(19) United States
(12) Patent Application Publication
(10) Pub. No.: US 2012/0009954 A1
(43) Pub. Date: Jan. 12, 2012

(54) Method and System for SMS-Based Electronic Form Processing

(75) Inventors: Arun Raju Gadiraju, Hyderabad (IN); Rambabu Palaka, Haryana (IN)

(73) Assignee: ISERV COMMERCE INDIA PVT. LTD., Hydrabad (IN)

(21) Appl. No.: 12/673,050

(22) PCT Filed: Aug. 12, 2008
(86) PCT No.: PCT/IN08/00510

§ 371 Date: Feb. 11, 2010

(30) Foreign Application Priority Data
Aug. 13, 2007 (IN) 1799/CHE/2007

(51) Int. Cl. H04W 4/14

(52) U.S. Cl. 455/466

(57) ABSTRACT

The present invention provides a method and system for electronic form processing in a cellular network that includes mobile stations. Mobile stations are provisioned with electronic form templates which can be used to complete electronic forms. These electronic forms are sent to a server using the Short Message Service (SMS) protocol. The server validates the electronic forms and requests invalid information from the mobile station. Once the electronic form has been validated, the electronic form is processed.

### BACKGROUND

The present invention relates to electronic form processing. More particularly, the present invention relates to a system and methods for presenting and processing electronic forms through a cellular network utilizing a Short Message Service (SMS) protocol.

Forms are required for various purposes, including but not limited to, registration of individuals, organizations, services, and products. With the advent of the Internet, electronic forms have virtually replaced paper based forms. Electronic forms facilitate fast information gathering and automated processing, saving substantial efforts, which a paper based form would otherwise require. Internet based electronic form processing is limited by Internet access and convenience of using Internet enabled-devices. Mobile phone networks, on the other hand, have a much higher geographical coverage. In fact, certain geographies have a higher mobile phone network penetration than the Internet.

Most of the existing mobile phones across the world are SMS protocol enabled. Therefore, SMS provides an easy way to transfer simple information of a limited length. An SMS is means for short text or information transfer using mobile phones. Usually a mobile phone provides software to enable communication using SMS protocol. A mobile phone user is provided with various options to perform desired tasks with short messages. For example, a mobile phone user can navigate to a text editor that enables the user to type a message using the mobile phone's key pad. The text editor is a simple text editor that does not have advanced formatting capabilities as available with various operating systems on personal computers. The user can then transmit the message to a desired mobile phone. The mobile phone transmits the message to the recipient phone using SMS protocol. The SMS protocol is a store-and-forward protocol. A message is transferred using SMS protocol as a protocol description unit (PDU). An SMS protocol PDU consists of text and meta-information about the sender. A PDU is transferred through the mobile network to the recipient. If the recipient mobile phone is switched off or out of coverage area of the mobile service, the message is stored at a service provider's end. The message is delivered to the recipient as soon as the recipient mobile becomes reachable to the service provider. A user can also read the received messages using the software provided on the mobile phones. Based on the capability of the mobile phone software, the user can further process received messages. Some of the basic processing features include forwarding a message, replying to a message, storing a message and modifying a message.

SMS messages are used for various data and query processing services including, but not limited to, banking services, location-based services, and information services. Most of these SMS based services are customized for specific applications. The applications using SMS based processing require forms that are usually menu or option driven. Users send SMS messages either as a request or in response to an SMS received from an application server. In some applications, single string SMS messages have also been used for form processing. In single string SMS messages, the entire form is provided as a single string and all parameters in the form are intermixed. The application server parses the forms based on strict rules and typically does not apply error correction.

Various applications require forms to be filled that are not menu or option driven. Present techniques of SMS based electronic form processing do not have provision for completing free forms for such applications. Further, the present techniques of SMS based form processing cannot be generically used across multiple services like user registrations, service provider registrations, service registrations, service requests, and information requests. The present techniques cannot process the SMS based forms in order to ensure the sufficiency or integrity of the information received from the users.

As a result, it is desirable to provide an SMS based form presentation and processing technique that enables free completion of a form similar to the electronic form completion on the Internet. It is also desirable to provide an SMS based form processing technique that ensures the sufficiency and integrity of the information filled in by the users. It is further desirable to provide an SMS based form processing technique that can be used across various applications which require parameterized text input.

### SUMMARY OF THE INVENTION

Accordingly, the invention provides methods and systems for electronic form presentation and processing in a cellular network. The electronic form presentation and processing according to the invention is facilitated using the Short Message Service (SMS) protocol. The cellular network may include at least one mobile station. The at least one mobile device is provisioned with a first electronic form template. Then, a first electronic form is received from the at least one mobile station. The first electronic form may include a first set of key-value pairs. The first electronic form is then validated.

In an embodiment of the present invention, the system for electronic form presentation and processing includes cellular network having at least one mobile station, a communication module, a first database, a processing module and a second database. The communication module enables the system to communicate with the at least one mobile station in the cellular network. The first database stores at least one electronic form template. Each of the at least one electronic form templates includes a set of keys. The processing module is capable of provisioning the at least one electronic form template to the at least one mobile station, and validating an electronic form received from the mobile station. The electronic form includes a set of key-value pairs. The second database is capable of being queried using the key-value pairs received from the mobile station.

In another embodiment, a method for electronic form processing in a cellular network is disclosed. The cellular network can have at least one mobile station. The method includes provisioning a message using SMS protocol to a mobile station. The provisioned message includes an electronic form template. The method also includes receiving an SMS based completed electronic form received from the said mobile station. The completed electronic form includes key-value pairs. The method further includes validating the received electronic form.

In yet another embodiment, a computer program product for electronic form processing in a cellular network is disclosed. The computer program code includes computer readable code embodied in a computer readable medium. The computer readable code includes instructions for provisioning a first electronic form template to at least mobile station in the cellular network. The computer readable code further includes instructions for receiving a first electronic form from the at least one mobile station. The first electronic form comprises a first set of key-value pairs. The computer readable code also includes instructions for validating the first electronic form.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 shows an exemplary wireless cellular network environment in which various embodiments of the present invention can be practiced;

FIG. 2 shows a system for electronic form processing in accordance with an embodiment of the present invention;

FIG. 3 illustrates an exemplary interaction between a mobile station and a server in accordance with an embodiment of the present invention;

FIG. 4 illustrates an exemplary interaction between a mobile station and a server in accordance with another embodiment of the present invention;

FIG. 5 is a flowchart illustrating a method for electronic form processing in accordance with an embodiment of the present invention;

FIG. 6 is a flowchart illustrating a method for electronic form processing in accordance with another embodiment of the present invention; and

FIG. 7 is a flowchart illustrating a method for electronic form processing in accordance with yet another embodiment of the present invention.

### DETAILED DESCRIPTION OF VARIOUS EMBODIMENT

Various embodiments of the present invention enable electronic form presentation and processing in a cellular network using Short Message Service (SMS) messages. Electronic form templates are made available to mobile stations that communicate over the cellular network. An electronic form template can be made available to a mobile station in a variety of ways. The electronic form templates can reside on the mobile station in the form of a pre-installed software utility. A mobile user can request an electronic form template from a service provider by sending a request message. A mobile user can be made available with the form template contents through media other than mobile for example internet and print media. Users of the mobile stations fill information into the electronic form templates to create completed electronic forms or electronic forms. An electronic form template includes a set of keys. An electronic form includes a set of key-value pairs such that each value is associated with a key. The key may correspond to a question on a form and a value may correspond to the user's response. The key in the electronic form may correspond to a key in an electronic form template from which the electronic form is created. The users then send the completed electronic forms to a service provider in the form of an SMS message. The service provider receives the completed forms and validates the key-value pairs in the electronic forms. Validation may require the service provider to send a response to the mobile stations requesting corrections in the forms, or for missing information. Once the validation is complete, i.e., all key-value pairs are valid, the service provider processes the form.

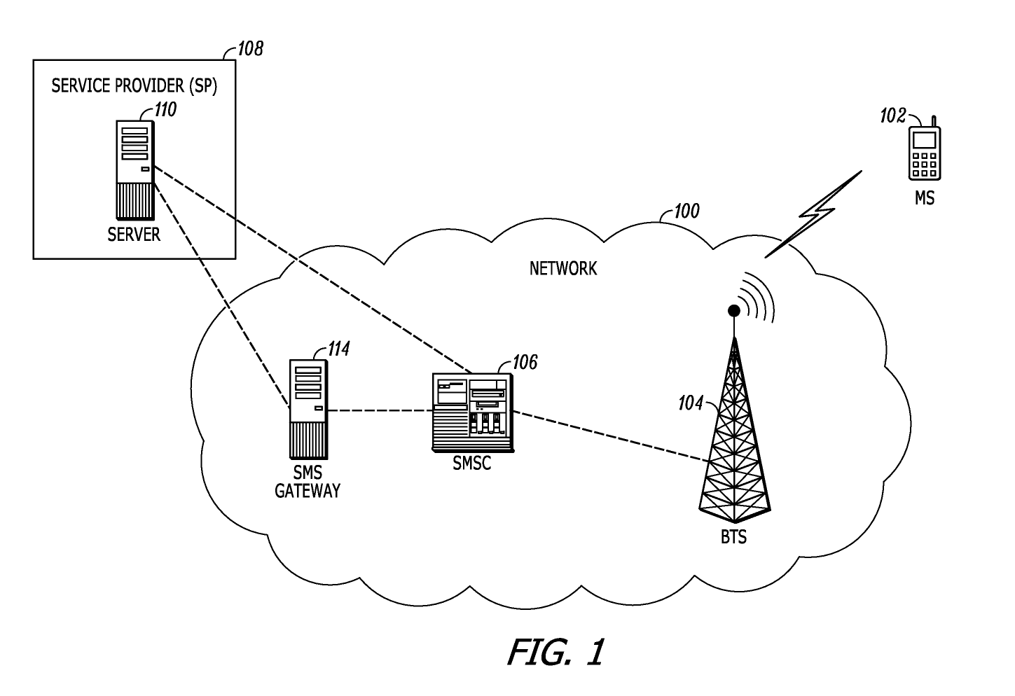

FIG. 1 shows an exemplary wireless cellular network environment in which various embodiments of the present invention can be practiced. A network 100 may include a plurality of wired and wireless networks, including but not limited to, a Global System for Mobile Communications (GSM) network, a Code Division Multiple Access (CDMA) network, a Public Switched Telephone Network (PSTN), and the Internet. The network 100 also may include various sub-networks, appliances, and service providers that enable wireless cellular communication between various subscribers. A mobile station (MS) 102 is capable of transmitting and receiving text messages using the Short Service Message (SMS) protocol, further details of which are available in a Third Generation Partnership Project (3GPP) technical specification 3.40, titled ‘Technical realization of the Short Message Service (SMS)’. Examples of the MS 102 include a mobile phone, a PDA or any other device capable of communicating using SMS protocol. A text message sent or received using the SMS protocol is hereinafter interchangeably referred to as a “message”. The MS 102 can be used by a user in order to perform various activities including creating, sending and receiving messages, among other activities. A message originating from the MS 102 is transmitted via a Base Transceiver Station (BTS) 104 to a Short Message Service Center (SMSC) 106. The SMSC 106 acts as a store-and-forward center for the message. The message may be forwarded to another mobile station or to a service provider (SP) 108. While the message is being forwarded through the network 100 it may undergo structural changes, for example, change in contents or structure of the header field or changes in file format. The service provider 108 may include a server 110. The server 110 is an application server. The server 110 is capable of transmitting, receiving, and processing the messages. In one embodiment, the server 110 communicates with the SMSC 106 for transmitting and receiving the messages. In another embodiment the server 110 communicates with an SMS Gateway 112 which is in communication with the SMSC 106, for transmitting and receiving the messages.

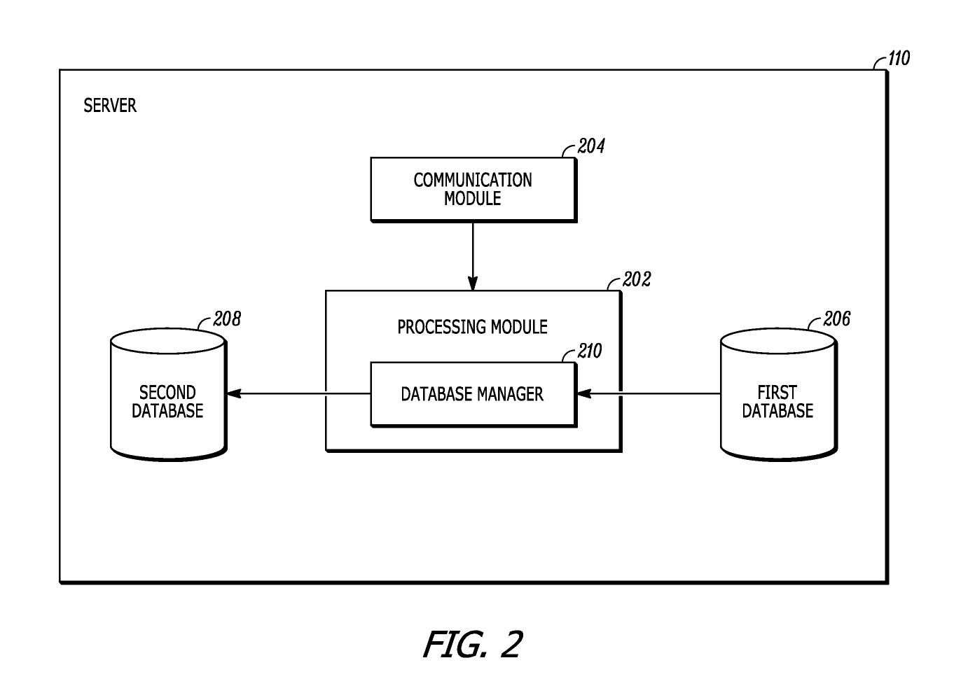

FIG. 2 shows a system for electronic form processing in accordance with an embodiment of the present invention. The system is implemented using the server 110. The server 110 includes a processing module 202, a communication module 204, a first database 206, and a second database 208. The processing module 202 includes a database manager 210 and a session manager 212. The processing module 202 is capable of processing messages. The communication module 204 enables the server 110 to communicate with the SMS gateway 112 and the SMSC 106. The database manager 210 is capable of parsing a set of key-value pairs received from the MS 102 and querying a first database 206 to obtain an electronic form template. The database manager 210 is further capable of querying a second database 208. While querying the second database 208, the database manager 210 can select, add, update, and delete information from the second database. The second database 208 may be an information database keeping record of information received from the MS 102. The session manager 212 is capable managing a user session with the MS 102. Interactions with one MS are managed as part a user session. The session manager 212 ensures that all interactions with an MS that relate to one service request are handled together and share information. To identify a user session, the session manager stores and uses a unique identifier for mobile stations. For example, the session manager 212 can use the mobile number of the MS 102 as its unique identifier. The modules within the server 110 as described above can be implemented as software, hardware or combinations thereof.

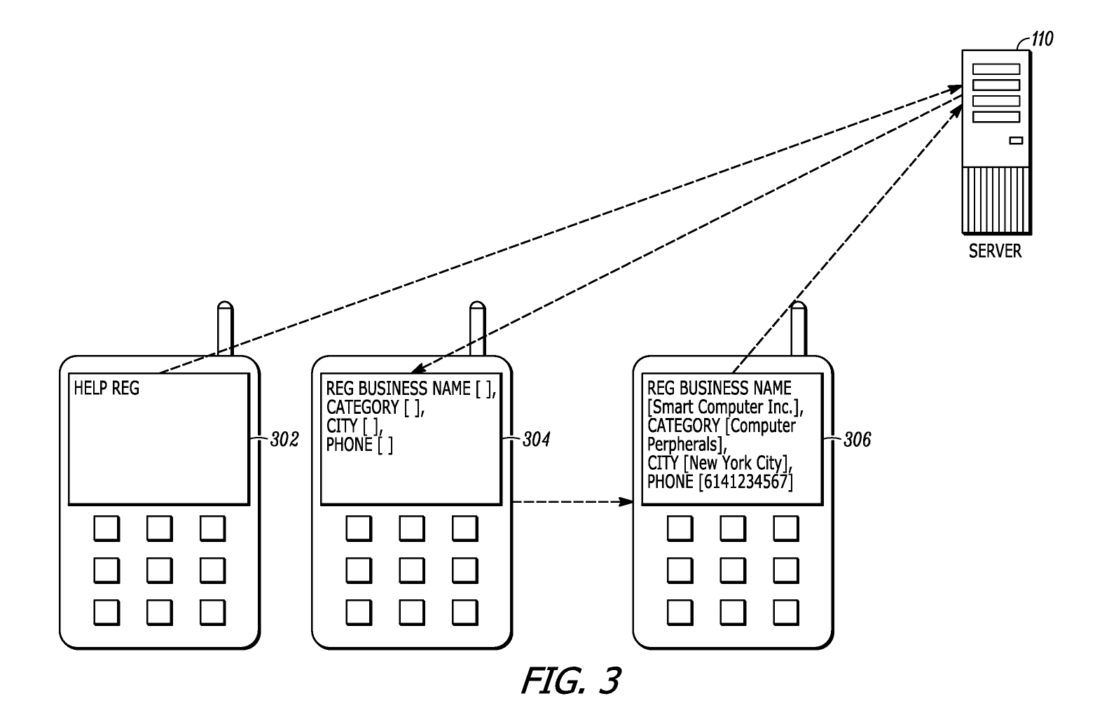

FIG. 3 illustrates an exemplary interaction between a mobile station and a server in accordance with an embodiment of the present invention. Various embodiments of the present invention find a variety of uses in user form registration procedures implemented by information service providers. An information service provider may provide information about specific local businesses in a particular geography to users requiring this information. For example, users may want to know a computer peripherals retailer in a particular area or location. A computer peripherals retailer would also like to provide the users with this information in order to boost its sales. The information service provider can effectively use an embodiment of the present invention to meet the needs of the computer peripherals retailer and the user requiring the information. For exemplary purposes, FIG. 3 illustrates an interaction between an MS 102 (shown in FIG. 1) and a server 110 (shown in FIG. 1), situated at the service provider 108 (shown in FIG. 1). In accordance with an embodiment of the present invention the service provider 108 (shown in FIG. 1) may be an information service provider. The exemplary interaction includes registering a company with the information service provider. Post registration, the registered information can be used by various users to identify the company with the products provided by the company. For example, as shown in FIG. 3 a representative of a computer peripherals retailer, Smart Computers Inc., creates a message 302 requesting a registration form from the information service provider by sending a message. The contents of the message 302 are as follows:

### HELP REG

It will be apparent to those skilled in the art that the text in the message 302 is exemplary. Any other text (for example, ‘SEND FORM’) can also be used. The message is received using the communication module 204 (shown in FIG. 2) either from the SMS gateway 112 (shown in FIG. 2) or the SMSC 106 (shown in FIG. 2). The database manager 210 (shown in FIG. 2) of the server 110 (shown in FIG. 2) parses the message to identify and process the request and then queries the first database 206 (shown in FIG. 2) for an electronic form template that corresponds to the registration request. The server 110 (shown in FIG. 2) then sends back a message 304 to the MS 102 (shown in FIG. 2) using the communication module 204 (shown in FIG. 2). The message 304 includes a registration electronic form template. As shown in FIG. 3, the message 304 includes a plurality of keys, blank spaces bound by brackets and delimiters for inputting the values corresponding to each of the keys. These blank spaces will be used by the user of MS 102 (shown in FIG. 2) to provide values corresponding to the keys. Keys in the message 304 are equivalent to fields in forms used in websites that gather and provide information using the Internet. The contents of the message 304 are as follows:

REG BUSINESS NAME* [ ],
CATEGORY [ ],
CITY [ ],
PHONE [ ]

In this form, ‘REG BUSINESS NAME’, ‘CATEGORY’, ‘CITY’ and ‘PHONE’ are keys. A comma (,) is an exemplary character that is used to delimit two keys at the end of a line. Therefore, the form comprises text. The entire form can be provided in a single line. Alternatively, a new line character ( [symbol] ) or a hyphen (-) may be used as the delimiter. Similarly, exemplary ways in which the blank spaces can be enclosed include parenthesis ( ) square brackets [ ], curly brackets { } and angle brackets < >. The representative from the computer peripherals retailer fills the registration form template with values. Some of the keys (indicated by an asterisk) may also be marked as mandatory keys.

As shown in FIG. 3, the message 306 includes a filled registration form. The filled form includes the plurality of keys received in the message 304 and the corresponding values filled by the representative of the computer peripherals retailer to form a plurality of key-value pairs. The values in the message 306 are equivalent to the information that a user fills in a form in a website. The representative from the computer peripherals retailer is required to fill the mandatory fields in order to get the registration form accepted by the information service provider. The contents of the message 306 are as follows:

REG BUSINESS NAME* [Smart Computers Inc.],
CATEGORY [Computer Peripherals],
CITY [New York],
PHONE [6141234567]

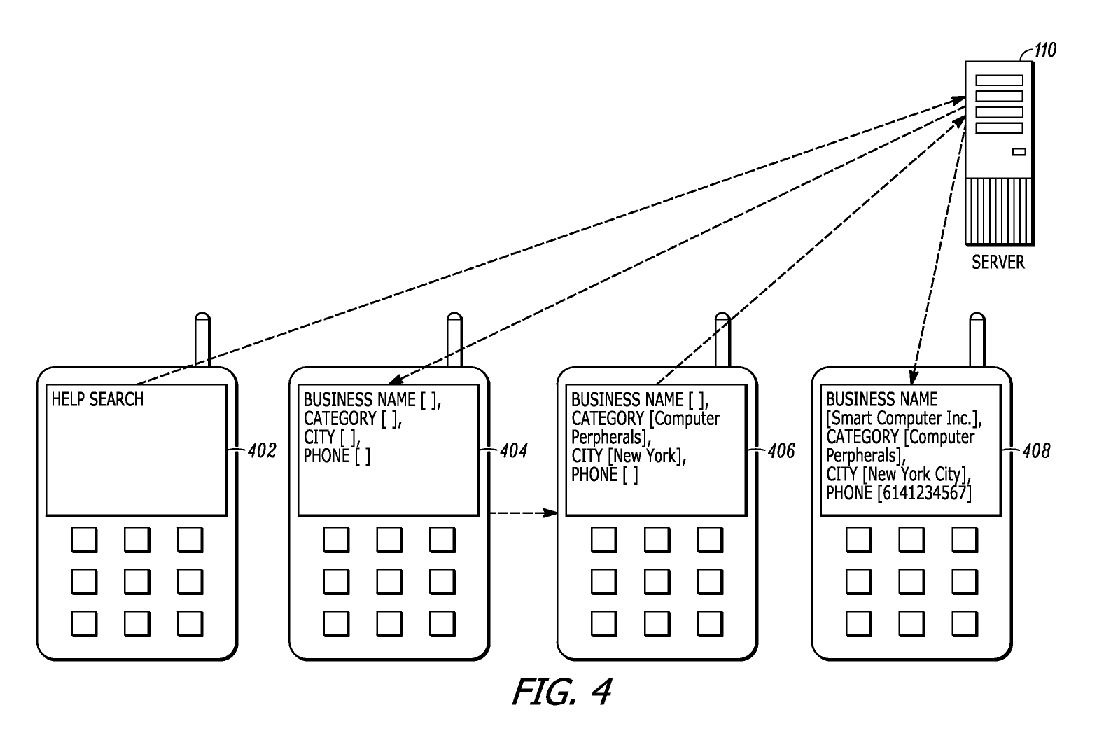

In the message 306, each key-value pair occupies one line of text. The representative of the computer peripherals retailer sends the message 306 to the information service provider. The server 110 (shown in FIG. 2) processes the message 306. The database manager 210 (shown in FIG. 2) creates a query for the second database 208 (shown in FIG. 2) requesting the second database 208 to store the contents of the message 306. Once the registration has been stored in the second database 208, the information provided in the message 306 can be made available to users requesting the name and contact details of a computer peripherals retailer in a particular area. It should be noted that various other embodiments can exist with respect to the registration form templates and the messages 304 and 306. It should be noted that the order of the key-value pairs is not important. A person filling the electronic form template is not restricted in selecting an option provided in the message 304 but can freely fill the values in appropriation with the keys. It will be apparent from the description of FIG. 4, the contents of the message 304 will correspond to the service being provided.

In certain cases, when the number of keys is large or it is expected that the values provided by a user may exceed the number of characters allowed in one message (for example, 160 characters), the form may be broken and sent to MS 102 (shown in FIG. 1) as multiple messages. The user can then respond to the multiple messages in one user session. Further, a decision tree can be established in order to facilitate customization of keys in a form based on the responses given to an earlier response. For example, a second form template may be sent when a user enters the category as Computer Peripherals. The second form template may inquire details regarding products that the computer peripherals retailer can provide.

FIG. 4 illustrates an exemplary interaction between a mobile station and a server in accordance with another embodiment of the present invention. A user requiring information about a computer peripherals retailer in his or her vicinity can send a message 402 similar to message 302 (shown in FIG. 3) requesting an information request form template. The contents of the message 402 are as follows:

### HELP SEARCH

The server 110 (shown in FIG. 2) at the information service provider responds to the request message 402 by sending a message 404 similar to the message 304. The message 404 includes an information request electronic form template. The server 110 (shown in FIG. 2) may query the first database 206 (shown in FIG. 2) to identify the information request form template based on the service requested by the user (in this case ‘SEARCH’). The contents of the message 404 are as follows:

BUSINESS NAME [ ],
CATEGORY [ ],
CITY [ ],
PHONE [ ]

The user fills the information request form template with appropriate request criteria. The message 406, in turn includes a filled information request form similar to the one in message 306. The contents of the message 406 are as follows:

BUSINESS NAME [ ],
CATEGORY [Computer Peripherals],
CITY [New York],
PHONE [ ]

The user sends the message 406 to the information service provider. The server 110 (shown in FIG. 2) at the information service provider receives the message 406. The server 110 (shown in FIG. 2) further processes the message 406. In response to the message 406, the server 110 (shown in FIG. 2) sends the requested information to the user in message 408. The server 110 (shown in FIG. 2) may query the second database 208 (shown in FIG. 2) to identify the requested information. The contents of the message 408 are as follows:

BUSINESS NAME [Smart Computers Inc.],
CATEGORY [Computer Peripherals],
CITY [New York],
PHONE [6141234567]

It should be apparent to those skilled in the art that the response could be in various other forms. For example, the message 408 may include only information that was requested and may not include keys. Further, information sent in the message 406 may not be repeated. In this way, the message 408 can provide more results that match the parameters provided in the message 406 while using the least number of characters. An exemplary alternative for the message 408 is shown below:

RESULT 1
Smart Computers Inc. 614 123 4567
RESULT 2
Computer Mart 912 345 6788

Thus, the information service provider provides the user with the contact details of a computer peripherals retailer in the New York region. The user can query the server 110 (shown in FIG. 2) in a plurality of ways. In another embodiment described in FIG. 4, the user can provide values for the keys CATEGORY and CITY. In response, the user receives the corresponding values corresponding to the keys BUSINESS NAME and PHONE. The user may, however, provide values corresponding to the key PHONE and in turn, and receive values corresponding to the remaining keys viz. BUSINESS NAME, CATEGORY and CITY.

FIG. 3 and FIG. 4 illustrate embodiments of the present invention used for the purpose of registration and searching. It should be apparent to those skilled in the art that electronic form processing can be used in various other applications including, but not limited to, online auctions, banking services, information services and social networking.

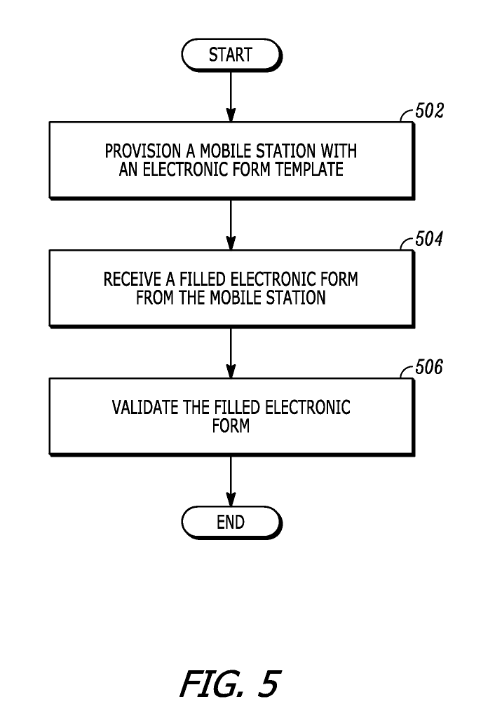

FIG. 5 is a flowchart illustrating a method for electronic form processing in accordance with an embodiment of the present invention. Block 502 depicts a step of provisioning an electronic form template to the MS 102. The step of provisioning includes providing the MS 102 with the electronic form template. The MS 102 can be provided with the electronic from template in a plurality of ways. In one embodiment, the MS 102 can transmit a request for the electronic form template to the server 110 (as described in conjunction with FIGS. 3 and 4). In response the server 110 may transmit the electronic form template to the MS 102. The MS 102 receives the electronic form template in the form of a message. In another embodiment, a software program having a library of electronic form templates may be installed on the MS 102. The MS 102 may use an electronic form template from the library of electronic form templates. In yet another embodiment, the MS 102 may download a set of electronic form templates including the electronic form template that it uses. Further, a user can input the electronic form template through a message editing application on the MS 102. For inputting the electronic form template the user can refer to electronic form templates published by the information service provider and provided in the form of a message. These electronic form templates may be published in a printed publication in the form of an advertisement, or on an Internet website maintained by the information service provider. Block 504 depicts the next step of receiving the filled form from the MS 102. Block 506 depicts the next step of validating the electronic form. While validating the electronic form, it is determined whether the electronic form comprises any invalid key-value pairs. Examples of invalid key-value pairs include a key-value pair wherein the value is empty for a mandatory key (indicated by an asterisk), a key-value pair in which a value does not match the format required by the key (for example, text in a phone number field), or a key-value pair in which the value cannot be parsed (for example, a mistake in the spelling of a city name). Further, validating could also require determining whether additional information needs to be sought. Once it is determined that at least one invalid key-value pair exists in the electronic form, a second set of keys that correspond to the at least one invalid key-value pair is identified. A second electronic form template is built from the second set of keys and is transmitted to the MS 102. The second electronic form gives an option for the user of the MS 102 to provide the missing information or correct the information provided in the first electronic form. A second electronic form will then be received from the MS 102 that corresponds to the invalid key-value pairs. It will be apparent to those skilled in the art that an indication of the type of error and a suggested solution may also be provided in second electronic form. This validation process of preparing electronic form templates based on invalid key-value pairs can continue till all key value pairs are valid and the electronic form can be processed.

To illustrate the validation by way of an example, consider that the user of MS 102 sends a request as shown below:

BUSINESS NAME [ ],
CATEGORY [Computer Peripherals],
CITY [New Xork],
PHONE [ ]

In this example, the user has inadvertently misspelled the city as ‘New Xork’ instead of ‘New York’. In accordance with the method as described above, this electronic form will not be parsed. An exemplary second electronic form template is shown below:

INVALID VALUE:
CITY [New Xork],
DID YOU MEAN:
CITY [New York]

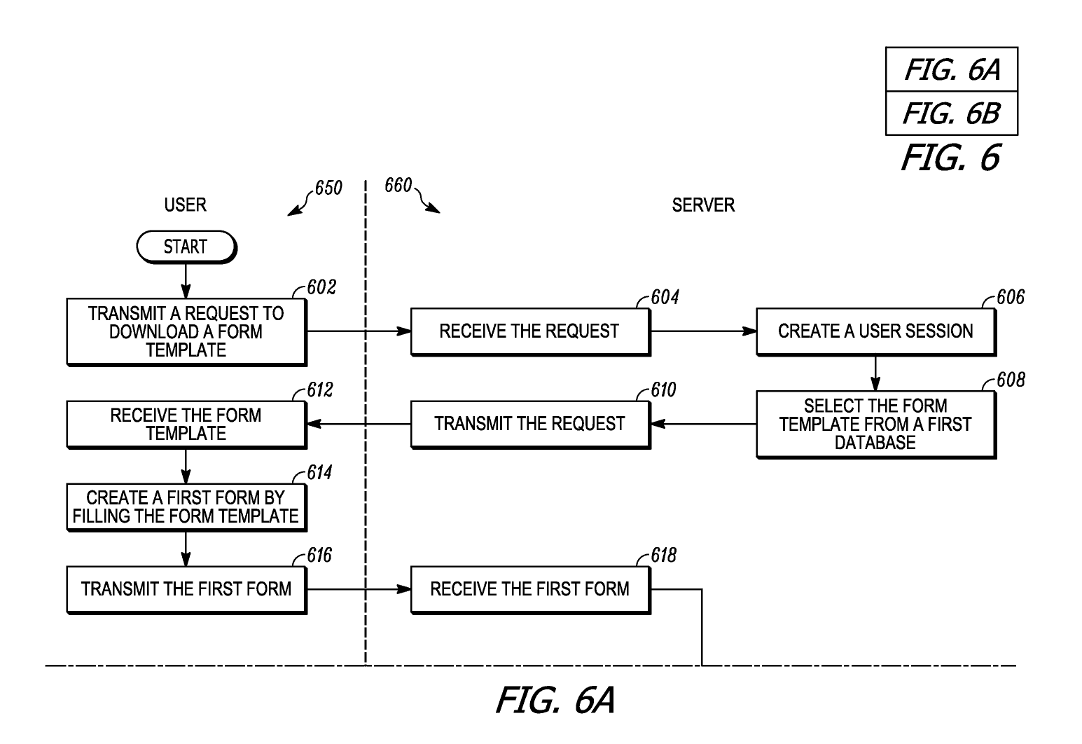

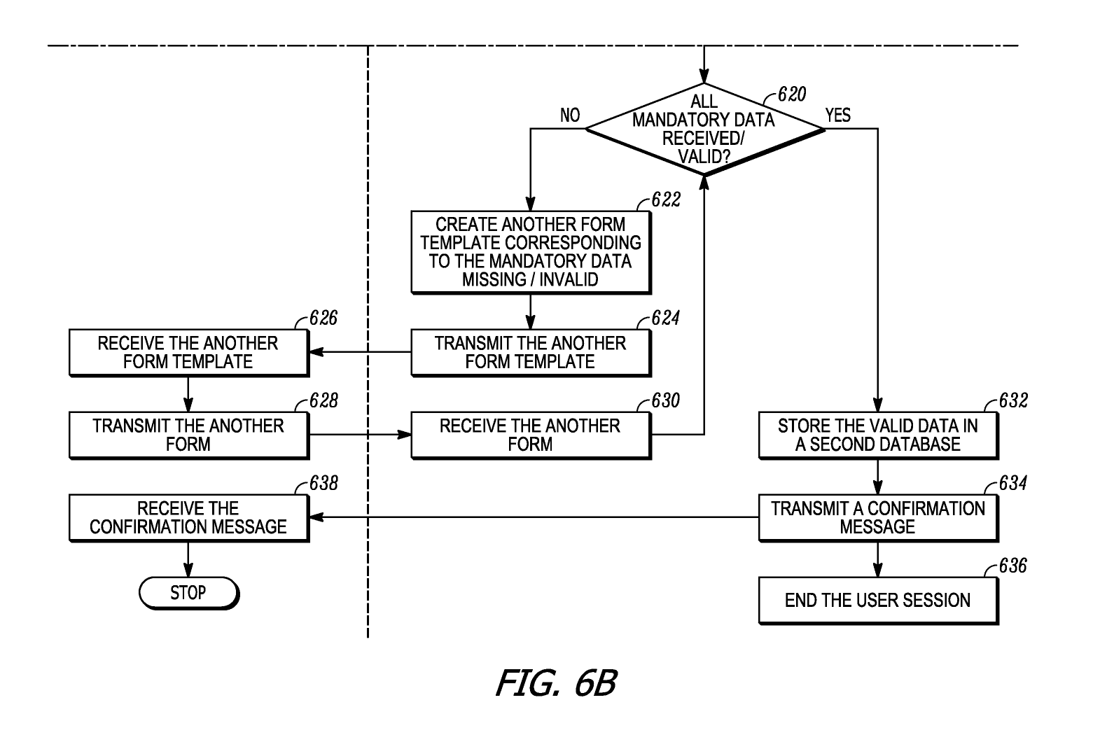

FIGS. 6A and 6B are flowcharts illustrating a method for electronic form processing in accordance with another embodiment of the present invention. The flow chart shown in FIGS. 6A and 6B depict a process of completing a registration form using the SMS protocol. FIGS. 6A and 6B are divided into two sections, a USER section 650 and a SERVER section 660. The tasks performed by the user using the MS 102 are depicted in the USER section 650, while the tasks performed by the server 110 are depicted in the SERVER section 660. A request to download an electronic form template is initiated by a user at block 602. The user sends a message in a specified format to a specified number requesting an electronic form template. Before the user requests a particular electronic form template, the specified format can be made available to the user in a plurality of ways as described in conjunction with FIG. 5. In one of the embodiments, this can be achieved by the user by sending a message having the following contents:

### HELP

In response, a comprehensive list or a catalog of request key-value pairs and their definitions can be sent to the MS 102 being used by the user. The user may then perform the task depicted in block 602. In another embodiment, periodic updates can be sent to users using SMS specifying the ways in which the users can request electronic forms.

The communication module 204 (shown in FIG. 2) receives the request at block 604. At block 606 a user session is created. Creation of the user session involves assigning a unique identifier to the user session. An example of the unique identifier is the mobile number of the MS 102 (shown in FIG. 2). The server 110 (shown in FIG. 2) starts processing the request after the step of user session creation. The database manager 210 (shown in FIG. 2) queries a first database to select the electronic form template at block 608. Further, the communication module 204 (shown in FIG. 2) transmits the form template to the MS 102 (shown in FIG. 2) at block 610.

The MS 102 (shown in FIG. 2) receives the form template at block 612. The user creates a first electronic form by filling the electronic form template at block 614. The user further transmits the first electronic form to the server 110 (shown in FIG. 2) at block 616. The first electronic form is received by the communication module 204 (shown in FIG. 2) at block 618. The information provided in the first form is then validated at block 620. The step of validation includes checking if all the mandatory fields are received. The step of validation further includes checking if the received data is valid. Each value within the key-value pair can be assigned certain attributes, examples of which include data type, range if the data type is a numerical value, and data format. The data type may be of the form character, string, integer, real number, or date. Various data filters can also be applied to determine the validity of values. For example, a certain user registration form may require a user to provide a date of birth. The date of birth may be required in an MM/DD/YYYY format. The step of validation may involve a filter to check if the date is valid. All the keys that do not pass the filter criteria applied in the step of validation are declared invalid during the step of validation. The second electronic form template is created using the invalid keys at block 622. The second electronic form template is transmitted to the MS 102 (shown in FIG. 2) at block 624.

The MS 102 (shown in FIG. 2) receives the second form template at block 626. The user fills the second electronic form template to create a message comprising a second electronic form. The user transmits the second electronic form to the server 110 (shown in FIG. 2) at block 628. The second electronic form is received by the communication module 204 (shown in FIG. 2) at block 630. The key-value pairs in the second electronic form are validated at block 620. This validation loop (blocks 620 through 630) is repeated to ensure that all key-value pairs are valid. The processing module 202 (shown in FIG. 2) performs the steps of validation of the first electronic form, creation of the second electronic form template using invalid keys, transmitting the second electronic form template to the MS 102 (shown in FIG. 2) and receiving the second electronic form till all the key-value pairs required are valid. The database manager 210 (shown in FIG. 2) stores the valid key-value pairs in the second database 208 (shown in FIG. 2) at block 632 using a query. The step of storing the valid key-value pairs can be performed in plurality of ways. In one embodiment, the second database can be populated iteratively during a particular user session. The valid set of key-value pairs can be stored in the second database during each iteration of the validation steps. If all the key-value pairs received by the server 110 (shown in FIG. 2) during the step of receiving at block 604 are valid, then all the key-value pairs are stored in the second database 208 (shown in FIG. 2) and no further information is requested by means of anther electronic form template. On successful storage of key-value pairs in the second database 208 (shown in FIG. 2), a confirmation message is sent to the MS 102 (shown in FIG. 2) at block 634 and the user session is ended at block 636 and. The user receives the confirmation message of successful registration form processing using SMS protocol on the MS 102 (shown in FIG. 2) at block 638.

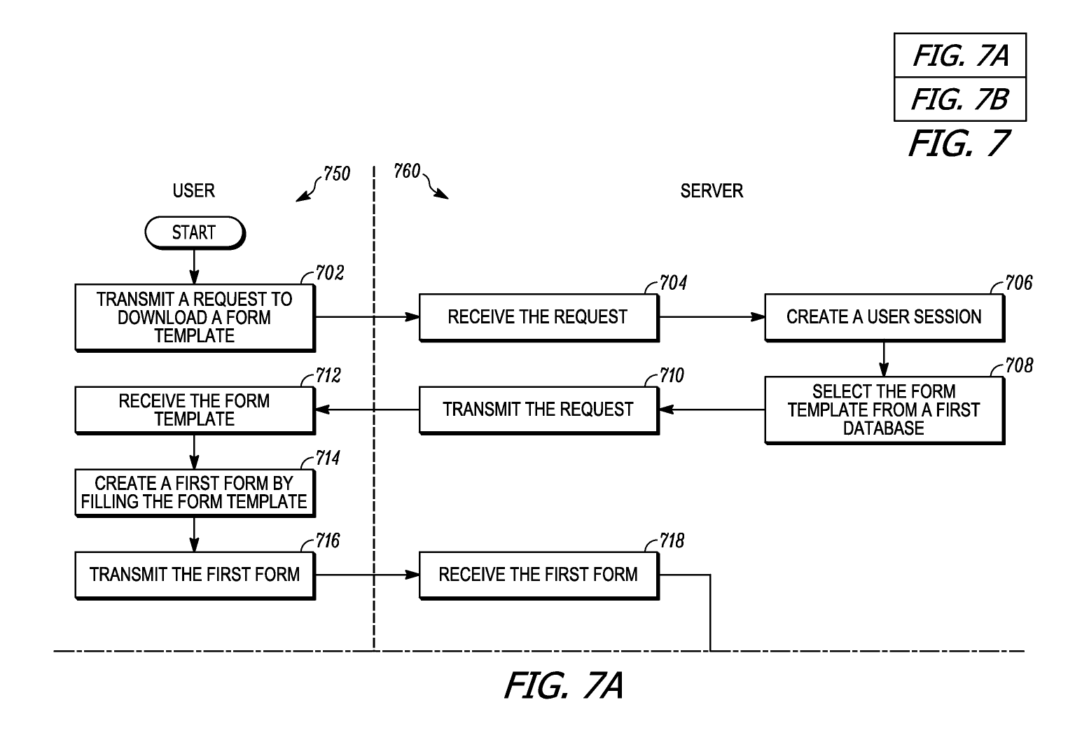

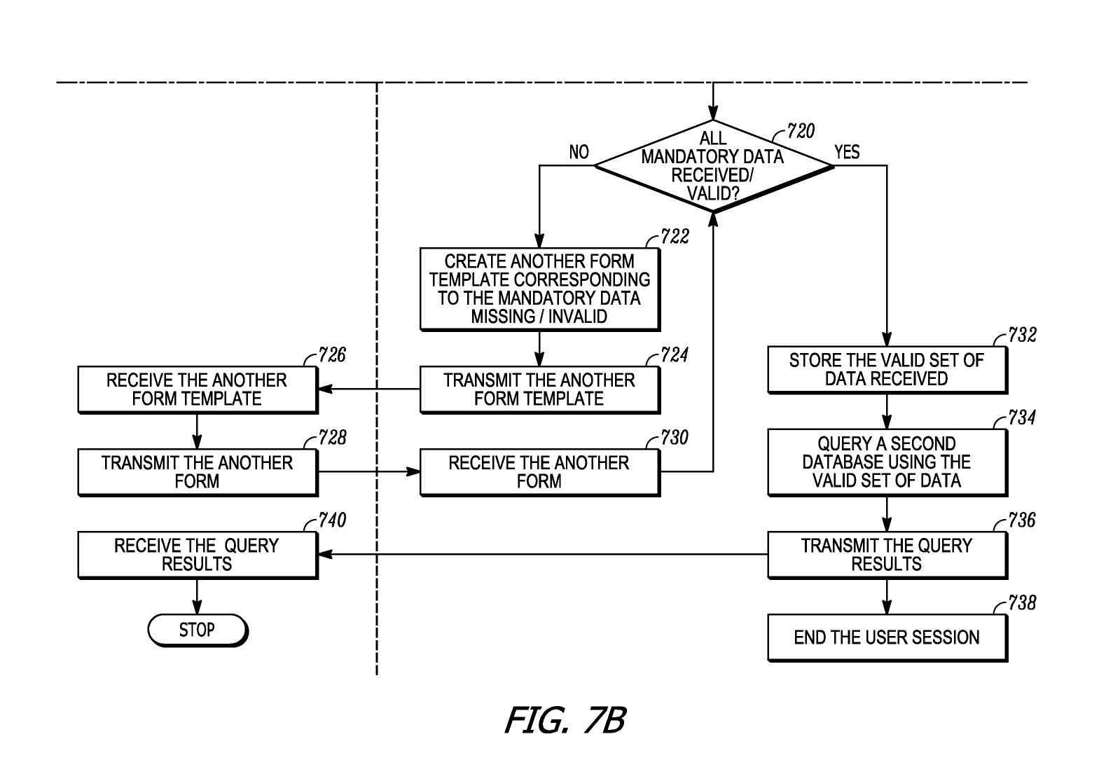

FIGS. 7A and 7B are flowcharts illustrating a method for electronic form processing in accordance with another embodiment of the present invention. The flow chart shown in FIGS. 7A and 7B depict an information provision process. An information request and a response corresponding to the information request are communicated using electronic forms sent using the SMS protocol. FIGS. 7A and 7B have two sections, a USER section 750 and a SERVER section 760. The tasks performed by the user using the MS 102 (shown in FIG. 2) are depicted in the USER section 750, while the tasks performed by the server 110 (shown in FIG. 2) are depicted in the SERVER section 760. A request to download an electronic form template is initiated by a user at block 702. The user sends a message in a specified format to a specified location requesting an electronic form template. Before the user requests a particular electronic form template, the specified format can be made available to the user in a plurality of ways. In one of the embodiments, this can be achieved by the user by sending a message having the following contents:

### HELP

In response, a comprehensive list or a catalog of request key-value pairs and their definitions can be sent to the MS 102 (shown in FIG. 2) being used by the user. The user then transmits a request to download an electronic form template at block 702. In another embodiment, periodic updates can be sent to users using SMS specifying the ways in which the users can request electronic forms.

The communication module 204 (shown in FIG. 2) receives the request at block 704. At block 706, a user session is created. Creation of the user session involves assigning a unique identifier to the user session. An example of the unique identifier is the mobile number of the MS 102 (shown in FIG. 2). The server 110 (shown in FIG. 2) starts processing the request after the creation of the user session. The database manager 210 (shown in FIG. 2) queries a first database to select the form template at block 708. Further, the communication module 204 (shown in FIG. 2) transmits the first electronic form template to the MS 102 (shown in FIG. 2) at block 710. The MS 102 (shown in FIG. 2) receives the form template at block 712. The user creates a first electronic form by filling the first electronic form template at block 714. The user further transmits the first electronic form to the server 110 (shown in FIG. 2) at block 716.

The first electronic form is received by the communication module 204 (shown in FIG. 2) at block 718. The information provided in the first form is then validated at block 720. The step of validation includes checking if all the mandatory fields are received. The step of validation further includes checking if the received data is valid as described in conjunction with FIG. 6. A second electronic form template is created using the invalid keys at block 722. The second electronic form template is transmitted to the MS 102 (shown in FIG. 2) at block 724. The MS 102 (shown in FIG. 2) receives the second electronic form template at block 726. The user fills second electronic form template to create a message comprising the second electronic form. The user transmits the second electronic form to the server 110 (shown in FIG. 2) at block 728.

The second electronic form is received by the communication module 204 (shown in FIG. 2) at block 730. The key-value pairs provided in the second electronic form is validated at block 720. This validation loop (blocks 720 through 730) is repeated to ensure that all key-value pairs are valid. The processing module performs the steps of validation of the first electronic form, creation of the second electronic form template using invalid keys, transmitting the second electronic form template to the MS 102 (shown in FIG. 2) and receiving the second electronic form till all the key-value pairs received are valid. The database manager 210 (shown in FIG. 2) temporarily stores the valid key-value pairs at block 732. If all the key-value pairs received by the server 110 (shown in FIG. 2) during the step of reception at block 704 are valid, then all the key-value pairs are stored and no further information is requested by sending further electronic form templates. The key-value pairs stored after validation are used to query the second database 208 (shown in FIG. 2) at block 734. The response to the query is the information requested by the user. The response to the query is sent to the user at block 736. Consequently, the server 110 (shown in FIG. 2) ends the session at block 738. The user of the MS 102 (shown in FIG. 2) receives a message including the requested information at block 740.

Various embodiments of the present invention have the following advantages over conventional SMS based electronic form processing techniques. Various embodiments provide an electronic form processing method based on the SMS protocol over wireless cellular networks, without the requirement of Internet connectivity. Various embodiments further provide a free electronic form processing method as compared to conventional menu-driven data and query processing methods. Further, a plurality of services based on simple electronic form processing can be enabled.

The system, as described in the present invention, or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system may comprise a computer, an input device, a display unit and the Internet. The computer generally comprises a microprocessor. The microprocessor is connected to a communication bus. The computer also includes a memory. The memory may include Random Access Memory (RAM) and Read Only Memory (ROM). The computer system may further comprise a storage device which can be a hard disk drive or a removable storage drive such as a floppy disk drive, optical disk drive, and the like. Storage devices can also be other similar means for loading computer programs or other instructions into the computer system.

The computer system executes a set of instructions that are stored in one or more storage elements, in order to process input data. The storage elements may also hold data or other information as desired. The storage element may be in the form of an information source or a physical memory element present in the processing machine. Exemplary storage elements include hard disks, DRAMs, SRAMs and EPROMs. The storage element may also be external to the computer system, and connected to or inserted into the computer for download at or prior to the time of use. Exemplary of such external computer program products are computer readable storage mediums such as CD-ROMS, flash chips, floppy disks, and the like.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The software program containing the set of instructions can be embedded in a computer program product for use with a computer, the computer program product comprising a computer usable medium having a computer readable program code embodied therein. The processing of input data by the processing machine may be in response to user commands, or in response to results of previous processing or in response to a request made by another processing machine.

While the foregoing is directed to embodiments of the present invention, other and further embodiments of the invention may be devised without departing from the basic scope thereof, and the scope thereof is determined by the claims that follow.

1-19. (canceled)

20. A method for electronic form processing in a cellular network, the cellular network having at least one mobile station, the method comprising the steps of:
provisioning the at least one mobile station with a Short Message Service (SMS) based first electronic form template;
receiving a Short Message Service (SMS) based first electronic form from the at least one mobile station, wherein the first electronic form comprises a first set of key-value pairs; and
validating the first electronic form.

21. The method according to claim 20, wherein provisioning the first electronic form template comprises at least one of:
transmitting the first electronic form template in response to a request for the first electronic form template received from the at least one mobile station;
publishing a set of electronic form templates for users of the at least one mobile station, the set of electronic form templates comprising the first electronic form template; and
installing a library of electronic form templates on the at least one mobile station, the library of electronic form templates comprising the first electronic form template.

22. The method according to claim 20, wherein the key-value pairs include a key corresponding to an inquiry on an electronic form and a value which corresponds to a user's response to the inquiry.

23. The method according to claim 20, wherein the key-value pairs are received from users completing the first electronic form using an SMS protocol.

24. The method according to claim 20, wherein the step of validating the first electronic form comprises the step of determining whether at least one invalid key-value pair is received.

25. The method according to claim 24, wherein an invalid key-value pair corresponds to a value that cannot be recognized or is incomplete.

26. The method according to claim 24, wherein the step of determining whether at least one invalid key-pair is received further comprises the steps of:
identifying a second set of keys corresponding to the at least one invalid key-value pair;
building a second electronic form template comprising the second set of keys;
transmitting the second electronic form template to the mobile station; and
receiving a second electronic form from the mobile station, wherein the second electronic form comprises a second set of key-value pairs.

27. The method according to claim 20, wherein validating the first electronic form further comprises sending a response to the mobile station.

28. The method according to claim 20, further comprising:
creating a user session; and
closing the user session.

29. The method according to claim 28, wherein creating a user session comprises assigning a unique identifier to the user session.

30. The method according to claim 20, further comprising querying a database using the first set of key-value pairs.

31. The method according to claim 30, wherein querying comprises updating an information database.

32. A system for electronic form processing in a cellular network, the cellular network including at least one mobile station, the system comprising:
a communication module capable of communicating with the at least one mobile station;
a first database capable of storing at least one electronic form template, wherein the at least one electronic form template comprises a set of keys;
a processing module capable of provisioning the at least one electronic form template to the mobile station and validating an electronic form received from the mobile station, wherein the electronic form comprises a set of key-value pairs; and
a second database capable of being queried using the set of key-value pairs.

33. The system according to claim 32, wherein the processing module comprises a database manager capable of querying at least one of the first database and the second database.

34. The system according to claim 32, wherein the electronic form comprises text, wherein each key-value pair corresponds to one line of text.

35. The system according to claim 32, wherein each of the set of key-value pairs comprises a key, a value and a delimiter.

36. The system according to claim 32, wherein the processing module comprises a session manager capable of managing a user session with the mobile station.

37. The system according to claim 36, wherein the session manager comprises a unique identifier for the mobile station.

38. A computer program product for use with a computer, the computer program product comprising a computer usable medium having a computer readable code embodied therein for electronic form processing in a cellular network, the cellular network comprising at least one mobile station, the computer program code performing:
provisioning the at least one mobile station with a Short Message Service (SMS) based first electronic form template;
receiving a Short Message Service (SMS) based first electronic form from the at least one mobile station, wherein the first electronic form comprises a first set of key-value pairs; and
validating the first electronic form.

39. The computer program product according to claim 38, wherein the computer readable code for provisioning the first electronic form template comprises computer readable code for at least one of:
transmitting the first electronic form template in response to a request for the first electronic form template received from the at least one mobile station; and
installing a library of electronic form templates on the at least one mobile station, the library of electronic form templates comprising the first electronic form template.

40. The computer program product according to claim 38, wherein the computer readable code for validating the first electronic form comprises computer readable code for:
determining whether at least one invalid key-value pair is received;
identifying a second set of keys corresponding to the at least one invalid key-value pair;
building a second electronic form template comprising the second set of keys;
transmitting the second electronic form template to the mobile station; and
receiving a second electronic form from the mobile station, wherein the second electronic form comprises a second set of key-value pairs.

41. The computer program product according to claim 38, wherein the key-value pairs are received from users completing the first electronic form using an SMS protocol.

42. The computer program product according to claim 38, wherein the computer readable code for validating the first electronic form further comprises computer readable code for sending a response to the mobile station.

43. The computer program product according to claim 38, further comprising computer readable code for:
creating a user session; and
closing the user session.

44. The computer program product according to claim 38, further comprising computer readable code for querying a database using the first set of key-value pairs.
